(19) United States
(12) Patent Application Publication
(10) Pub. No.: US 2009/0083054 A1
(43) Pub. Date: Mar. 26, 2009

(54) Process to determine the authenticity context and quality context of products

(76) Inventors: Sing Chi Koo, Cupertino, CA (US); Connie Lai Ying Chun, Cupertino, CA (US)

Correspondence Address: Sing Chi Koo, 10139 Mello Place, Cupertino, CA, 95014, US

(21) Appl. No.: 11/903,025

(22) Filed: Sep. 20, 2007

(51) Int. Cl. G06Q 99/00; G06F 17/30

(52) U.S. Cl. 705/1

(57) ABSTRACT

The information surrounding the manufacturing of a product is called a manufacturing context. The manufacturing context of a product provides details about the source and quality of raw material together with the detail of manufacturing and quality assurance throughout the manufacturing process. A product identifier is a unique identifier generated from a manufacturing context to uniquely identify one or more products manufactured under the same condition. Information about a retailer and its environment is called a retailer context. A retailer identifier is a unique identifier that identifies a retailer context. A product's authenticity context is comprised of the authenticity of a product and the authenticity of a retailer. The production identifier and the retailer identifier are made available to consumers at the point of sale so that the authenticity context can be determined. This process enables a consumer to determine if a product is genuine and that the retailer is authorized to sell a particular product in a point of sales environment. Upon matching the context identifiers through a Web service provided by the manufacturer, consumers can obtain additional details regarding information that is particular to the product, such as quality control information recorded during the manufacturing process. In doing so, consumer confidence about a product is increased.

### I. BACKGROUND OF THE INVENTION

Global trade and modern supply chain systems enable products to be manufactured anywhere in the world, thus lowering the cost of manufacturing. This competitive environment has driven merchants to seek for further reduction of costs by manufacturing products with substandard materials and assembly procedures. Reputable manufacturers have becomes victims to unscrupulous competitors whose substandard look-alike products often confuse consumers. This is especially critical and sometimes fatal when the product involved is medicine or related directly or indirectly to our personal health. In the past, manufacturers all over the world have been trying to come out with a way to ensure their customers are buying genuine products. These methods, however, have not been particularly effective at curbing counterfeiting and substandard products from hitting the market.

As a result of an increase in global trade and the development of regional markets, manufacturers often use price incentives in different regions of the world to balance out the differences in economics and standards of living. A “gray market” is a term used to describe a genuine product being sold in non-manufacturer authorized channels. For example, the price tag of a Mercedes-Benz automobile is different in Europe than in North America because differences in federal regulations. Less reputable resellers would import European Mercedes cars and resell them in North America at lower price and a higher profit. In practice many consumer products are less obvious than cars, when product is genuine and yet un-authorized by the manufacturer, it is unlike to be covered by manufacturer's guarantee. The present invention goes beyond establishing authenticity for genuine products, it also provides consumer with the information to highlight such product deficiency.

It is another aspect of the present invention to provide a mechanism for establishments to re-certify used products as good quality and genuine. For example, a watchmaker may want to allow retail stores to sell its stash of trade-in watches as factory or expert certified quality pre-owned watches. The present invention will enable consumers to authenticate the product and to be sure that they are purchasing it from a factory authorized reseller.

A. Field of the Invention

The present invention is in the field of product authenticity and verification. Many manufacturers have been using methods in conjunction with elements such as original certificate, laser imprinting, serial numbering, watermarking, and graphical images to determine the authenticity of a product after it is marked for commerce. Over the years, counterfeiters have successfully duplicated these methods and procedures, making it impossible for consumers to trust the authenticity even though the product bears all the identity markings of the real thing. This is a serious problem facing every company all over the world. Counterfeit parts and products tend to just bear the look but not the durability, functionality, or usability. If it is an aircraft part, a plane may crash because of it. If it is medicine, people may get sick or die. If it is a toy, a child may be poisoned or hurt. All these undesirable consequences are enough to raise the alarm for every consumer. In recent years, product safety has become an ever-serious topic with millions of products, such as lead-contaminated toys, are the subject of massive nationwide recalls. Consumers are nervous about the quality of the product, especially those imported from oversea. When consumers lose confidence in a product's authenticity and genuineness, a broader understanding of the manufacturing context becomes essential in re-establishing consumer confidence.

Aside from the price of products, consumers are concerned about the genuineness of a product and whether or not product quality meets consumer safety guidelines. To this end, more and more manufacturers are warranting the safety of their products by either sampling inspections or direct inspections. After all these are said and done, the questions remain are (1) how can the consumer know that the product is genuine and (2) how can the consumer learn about the quality assurance procedure behind each of the product they buy. In view of the volume of product recalls in recent years, the present invention will help to rebuild consumer confidence.

B. Discussion of Prior Art

The present invention is a new method that helps the consumer verify the authenticity and quality assurance of products using an interactive procedure via the Internet. More particularly, in the use manufacturing data and retailer's identity as the key elements in the determination of the authenticity of product. This is a novel and useful approach to product authenticity. This new approach differs from process and methods previously disclosed.

United States patent U.S. Pat. No. 6,442,276 B1, Doljack describes a method to verify the authenticity of products by use of random numbers. This method assigns random code to a good and the encrypted version is marked on the good. The code is then stored in the database for future comparison. Encryption and decryption procedures are used to manipulate the code marked on the good so that a clear comparison against code stored in the database can be made. A good is authenticated if there is a match. Other than the use of a database to store a code and marking a good with a code, there is nothing in common between the present invention and Doljack's method. The present method does not rely on any random encrypted code to authenticate a good. Rather, the code is made up of two elements and one of them is derived from the identity of the point of sales retailer. Furthermore, the present invention uses Internet Web service to enable the user to match the codes from the product with the manufacturers database. The use of the Internet as the medium for product authentication is not disclosed in Doljack's method.

U.S. Pat. No. 5,367,148, Storch et al describes using random number in conjunction with a database to mark a good and to prevent counterfeiters from discovering its method of comparison between the number marked on a good and the authenticated number stored in the database. In the present invention, authentication is not dependent on any of the method disclosed by Storch et al, instead, it relies in part an element derived from the identify of the point of sales retailer.

U.S. Pat. No. 6,625,402 B2, Takemoto describes a method to authenticate an image forming cartridge product with Web access. The only similarity between Takemoto and the current invention is the use of the Internet as a mechanism in authentication. Otherwise, there is no similarity between the two methods. Furthermore, Takemoto's method is very product specific, as opposed to the current invention that is applicable to products and goods of all kinds.

U.S. Pat. No. 7,156,305 B2, Swan et al describes a method that uses radio frequency (RF) tag information as the basis for authenticating a product. Other than a shared objective of product authentication, there is nothing in Swan that resembles to the current invention.

U.S. Pat. No. 6,030,657, Butland et al describes a method that uses a biologic marker labeled with an agent that works in conjunction with infrared radiation detector. Other than it shares a common objective of preventing counterfeit product, there is nothing in common with the current invention.

United States patent application 2007/0056041A1, Goodman introduces a method that uses an authentication code to authenticate a product, and then subsequently, enables the authentication inquirer to add an additional party-specific code for future authentication. The similarity of this method to the current invention is that it uses more than one code to authenticate, and it uses the Internet as a mechanism to connect the authenticating authority, manufacturer, and the authenticator. Although Goodman's invention can authenticate a genuine product, it fails to address manufacturer-authorized products. In Goodman's invention, a 3^{rd} party is able to modify the authentication of the product—authentication that may be misappropriated. Moreover, Goodman's invention does not address the notion of point of sales retailer identity and authorization. Our present invention disallows 3^{rd} parties from enhancing or extending the authentication code. The one who owns, makes, distributes the product is the one who carries out the entire authentication content and procedure. Our present invention enables the consumer to verify factory-authorized reseller authority on a particular product. United States patent application 2005/0165792 A1, Ogihara et al discloses a method that uses a tag to track the shipping data together with sender and receiver information so as to determine the authenticity of products being distributed. The method relies on the context of this data in its decision making process, such as taking into consideration the reasonable shipping time between two locations. The similarity with the current invention is in the area where context is used. However, the nature of context is difference, and moreover, Ogihara et all is not addressing authentication from the point of view of a consumer. Ogihara is concerned with a dynamic context established between two transit points as a way to authenticate a product being shipped between an origin and a destination. In the current invention, this method does not apply. The location data and time factor between the movement of the product between intermediate warehouses offers no value to the present method used in authenticating the product. It is at the point of sales that the product is evaluated for authenticity. The current invention is based on the fact that the manufacturer knows who is authorized to sell the product, and the consumer knows who is selling the product. This information is then used to match against the manufacturer's record so as to determine the authenticity of the product. Whereas, Ogihara et al is only concerned that what is shipped from the shipper is received by the receiver. In the current invention, it is for the consumer at the point of sales to review the context data to get assurance that the good is authentic and is from the manufacturer.

United States patent application 2007/0180248 A1, Ecublens et al discloses a method to generate a certificate at the time of sales which is derived from the manufacturer's product ID code and the buyer's identity. It does not address any of the point of sales retailer's context nor does it address the genuine, but unauthorized products (gray market products). Whereas in the current invention, the point of sales retailer ID plays a important role in determining the authenticity of the product.

United States patent application 2006/0010503 A1, Inoue et al describes the use of a non-contact tag associated with the product and then stores such ID in advance in a database that can be accessed via Internet. Subsequently, the distributor and dealer use a reader to read the ID from the tag and then match that against the one stored in the database via an Internet application. This method did not taken into consideration of gray market products, nor point of sales retailer's identity context from the consumer's point of view. It does not address the consumer's need to authenticate the product. Whereas, the current invention provides a full account of the authenticity of the factory authorized retail chain. Moreover, the current invention does not require the use of non-contact tag.

United States patent application 2007/0198569 A1, Johnston describes a method to generate a unique, random, and unpredictable ID to an object. The consumer of the object would use a telephone system or Internet application to verify the validity of the code against a database that previously recorded each of the code issued to the object. This method did not use any point of sales retailer context as a factor in the generation of the code, and thus retailers cannot provide proof of manufacturer authorization to resell the product. The current invention provided a solution to address this subject matter in detail.

United States patent application 2003/0085800 A1, Li at el describes a method using an authenticator with a processing module and an information storage module having stored data to authenticate data retrieved by an interface device from the product. Authenticity is determined by matching a combination of the data provided by the interface device and the stored data against the authenticating data stored in the processing module. This implementation does not resemble in any way of the authentication apparatus used in the present invention. The only similarity with the current invention is the matching of code retrieve from the product. Even then, the point of sales identity used in the current invention is not necessarily obtained from the product, rather it can be made available to the consumer as part of the sales transaction.

United States patent application 2005/0234823 A1, Schimpf describes a method that consists of calculation and verification of encrypted sequence applied upon data retrieved from the product and comparing it with data stored on a computer system in order to determine the authenticity of the product. It does not take into consideration of the point of sales retailer's identity. Although it provides a mean for authorities, dealer, or consumer to validate the authenticity of a product, it does not account for the distinction of gray market products as provided by the current invention.

U.S. Pat. No. 7,260,553 B2, Ebert describes a context aware method to track objects. Object tracking is performing by both physical identifier and one or many contexts that describes the environment when the tag is read. Information such as the location data will become part of the context data. Although Ebert used the notion of context in conjunction with its tracking objective, it is used in the context of verifying the movement of an object in transit, such context does not bear any value in the authenticity of a product. The current invention uses a manufacturer's context and retailer's context to provide a means for the consumer to determine the authenticity of a product. Both contexts are fixed prior to performing an authenticity inquiry. The retailer's context is designated prior to distribution and is not dependent on the environment at the time the inquiry is made.

United States patent application 2007/0185788 A1, Dillon uses a unique code to mark each product, and uses an Internet server to lookup the code for sequent comparison. The method puts emphasis on the logic used in generating the code. In the current invention, authentication is based on codes that are derived from the manufacturing context and the point of sales retailer context.

United States patent application 2007/0200335 A1, Tuschel et al describes the method of using two sets of identifiers derived from markings on the object to establish the basis for determining the authenticity of a product. One set is read and sent to a remote location and in return receives a second set of identifier. This second is then compared with the remaining identifier in order to determine the authenticity of the product. This method bears no resemblance to the method used in the current invention. The current invention does not rely on such interactive technique to compare the identifiers.

United States patent application 2007/0119929 A1, Swan et al uses radio frequency tag to determine the authenticity of a product. This approach has no resemblance to the current invention, since the current invention does not use any radio frequency tags.

C. Problems with the Prior Art

Many of the prior arts discussed above are constrained by the requirement to hide or disguise the authentication code from the counterfeiters so that they are not able to use the code in their counterfeit products. The current invention is free from this constraint. It is important to point out that this invention is designed to defeat any attempt to market counterfeit products or unauthorized products that infringe upon the rights of the original manufacturer even if the PID or RID is copied by a counterfeit product manufacturer or non-authorized reseller. This is because RID is not assigned until the distributor determines which retailer is going to put the product on the shelf. Thus, consumers know who is authorized by the manufacturer to sell the product (i.e., retailer's identity). A consumer can use the Web service to seek out and identify and address associated with the RID. Even if the PID and RID are copied and labeled onto a counterfeit product or non authorized product, the fact that it was sold by a retailer that differs from the one corresponds to the RID will reveal the false pretense of the retailer.

### II. SUMMARY OF THE INVENTION

The present invention uses a database system to record a minimum of two identifiers into a database system for each instance of product before the product is distributed to a retailer. These identifiers together with a Web service represented by an Internet universal resource locator (URL) from the manufacturer are then made available to the consumer when the product is sold. The URL points to a Web page where the consumer can enter the identifiers and receives information about the specific instance of the product. Typically the information returned from such Web request reveals information such as the identity of the retailer, the quality inspection procedure applied, and the corresponding result from the inspection.

The two basic identifiers (ID) are production identifier (PID) and retailer identifier (RID). PID is an ID that is generated by the manufacturer from the manufacturing context. PID needs not to be unique. It identifies the applicable things such as raw material source, assembly line, the quality assurance finding, and accessories. RID is an ID that is created by the manufacturer in conjunction with the distributor to identify the distribution end point, and is typically the point of sale retailer in most cases. In situation where a regional retailer may receive it first and then further distributes it to different stores, the RID may represent the retailer chain. The detail account of the retail chain can be disclosed as part of the information revealed to the consumer when the PID and RID are used in conjunction with the manufacturer's URL during the authentication process. The purpose of the RID is to provide a consumer with a reconcilable context so that the consumer can draw a relationship between the name and/or location associated with the RID and the seller (retailer).

Typically the PID is made up of a sequence of code that uniquely identifies the suppliers, manufacturing date, place of manufacturing, production line, batch, and serial number. After the product is made and is ready for retail packaging, an inspection is given. If it is a good that requires no manufacturing (i.e. oranges), then the retail packaging unit of the good will be treated the same as a manufactured product (i.e. a pre-grouped bag of oranges). After product inspection, a PID is assigned and attached to the product. The product and its packaging material are considered as a retail product. An inspector will use a computer application to enter the results of the inspection. Rejected product will not be entered, or if it is to be entered, it will be marked accordingly. The product is then packed and shipped to warehouse for distribution to retail shelves. Data records from the inspection are made available to a computer system that is connected to the Internet. A retailer identifier is a unique ID that is used to identify a location where the product is sold to the consumer.

Typical RID is made up of a code that can be traced to a specific retailer. Examples of these codes are co-ordinates from the readout of a global positioning system (GPS) where the retailer is located, an ID that is used by the distributor to determine where the products to be shipped, or a zip code that identifies the locale of the retailer. Before the product is shipped to the retailer, the RID that corresponds to the retailer is updated to the record. The data repository that hosts this record resides in a computer system provides a Web service corresponds to the URL that is disclosed to the consumer. When the product is finally sold to a consumer, the retail packing or the receipt will include the RID as part of the retail package. Consumer can then use the PID and RID to access the information provided by the Web service. If the record is found, this implies that the retail product is genuine. Further review of the information returned by the Web service will reveal the quality-assurance data to the consumer, i.e., inspection frequency, nature and details of tests performed, analog or digital readout from test instruments, expression of visual inspection etc.

### A. OBJECTS AND ADVANTAGES OF THE INVENTION

As stated in previous paragraphs, there are many attempts to devise solutions to solve the authenticity of a product after it is marked for commerce. However, there exists no prior art that address the authenticity context. There is no prior art that uses consumer point of sale information as an element in the determination of product authenticity. Authenticity context is very important to both consumer and manufacturers. For example, although gray market products may be authentic products, they are not eligible for manufacturer's warranty because they are not sold by a manufacturer-authorized retailer. The use of authenticity context will also help to discourage the sales of misappropriated products. It can also help to distinguish manufacturer's OEM brand from its name brand. The major advantages of the present invention over the prior arts are:
1. The current invention uses an authenticity context to authenticate a product, the context can be used as the basis to distinguish genuine and manufacturer authorized product from a counterfeit product or genuine but non-authorized product even if the counterfeit product or non-authorized product is labeled with the duplicated context code.
2. The authentication relies on the point of sales retailer identity and a context code assigned by the manufacturer to give the consumer a context of authenticity of the product.
3. This invention uses the context of authenticity as a mean to authenticate a product. The authenticity context describes the manufacturing context and the retailing context. Subject to the evaluation of this context, the consumer and retailer can draw its conclusion regarding the authenticity of the product, even if a product is genuine.
4. This invention uses consumer's knowledge about the retailer as a decision factor to determine if the product is genuine and that the retailer is authorized by the manufacturer to sell this product.

### III. BRIEF DESCRIPTION OF THE FIGURES

FIG. 1 illustrates a process from product manufacturing to consumer fulfillment

FIG. 2 depicts the process of capturing the manufacturing context, recording it into a data repository, and assigning it to a product

FIG. 3 illustrates an input screen used during the inspection process

FIG. 4 illustrates the assignment of retail context to the product

FIG. 5 illustrates the input screen used in the assignment of retailer ID (RID)

FIG. 6 illustrates the authentication process

FIG. 7 illustrates the input screen used in the authentication process

FIG. 8 illustrates the authentication logic

### IV. DETAILED DESCRIPTION OF THE INVENTIONS

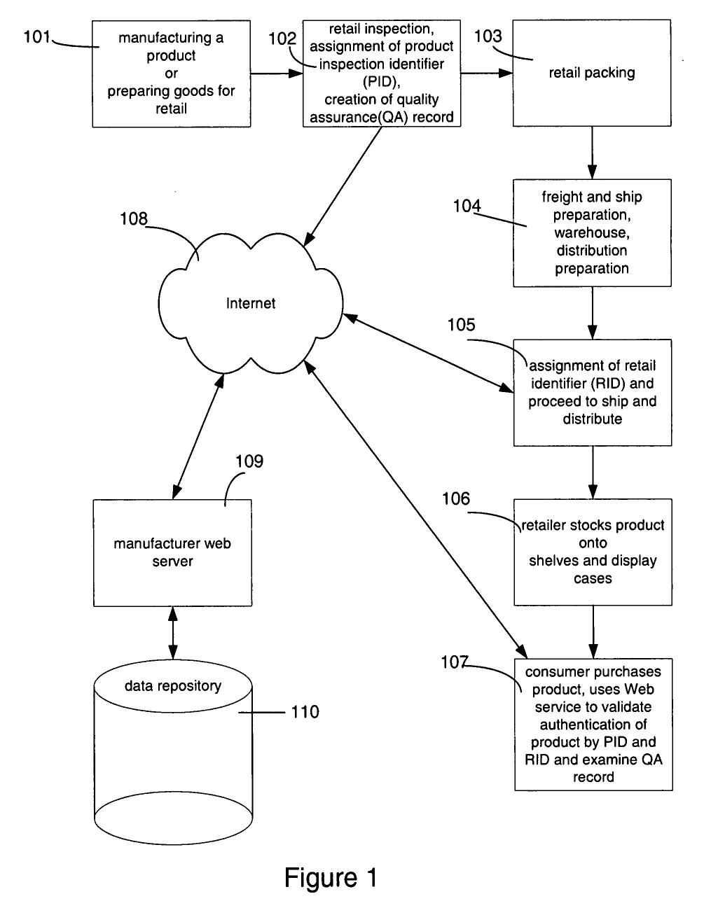

FIG. 1 shows a process diagram depicting the entire process from the start of manufacturing a product 101 to the sales of the product to a consumer 107. Upon completion of manufacturing 102 and prior to retail packing 103 and mark for commerce, the product is inspected and assigned with an product identifier (PID), the PID together with the manufacturing context is submitted to the manufacturer's Web server 109 via the Internet 108. The information is then stored in a data repository 110.

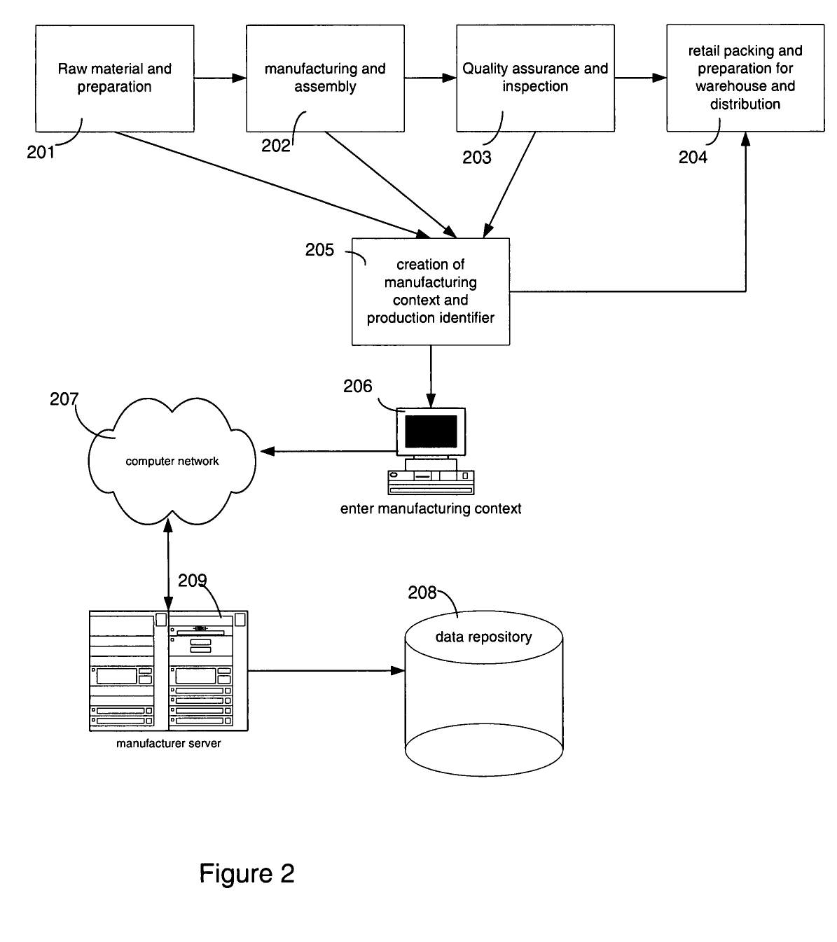

FIG. 2 shows a diagram that describes the procedure of collecting manufacturing context. After raw material is collected and prepared for manufacturing 201, the manufacturing and assembly process takes the raw material and converts it into a product 202. Subsequently, the product is subject to quality assurance inspection 203 before it is ready for retail packing 204. Data collected during this process forms the basis for the manufacturing context 205. The manufacturing context is then reduced into a product ID 205 and is then submitted to a computer system 206 that records the information onto the manufacturer's server 209 and data repository 208. The computer system 206 is connected to the manufacturer's server via a computer network such as the Internet. Each product made with the same manufacturing context will be assigned with a PID. PID can be unique for each product, or can be shared among several products that share the same manufacturing context. For example, the raw material and source, assembly line, and date of production are identical, and the quality control yields the same result on a batch of product, then the entire batch can share the same PID. However, if the manufacturer desired to track each product separately, then each product must be given a separate PID. This can be done by appending to the shared ID derived from the manufacturing context with a unique code, such as a serial number or one that is non-repetitive random number.

The PID is then associated to the product. Typically, it is labeled or tagged onto the product. The product is then ready for shipping 104 to destination warehouse.

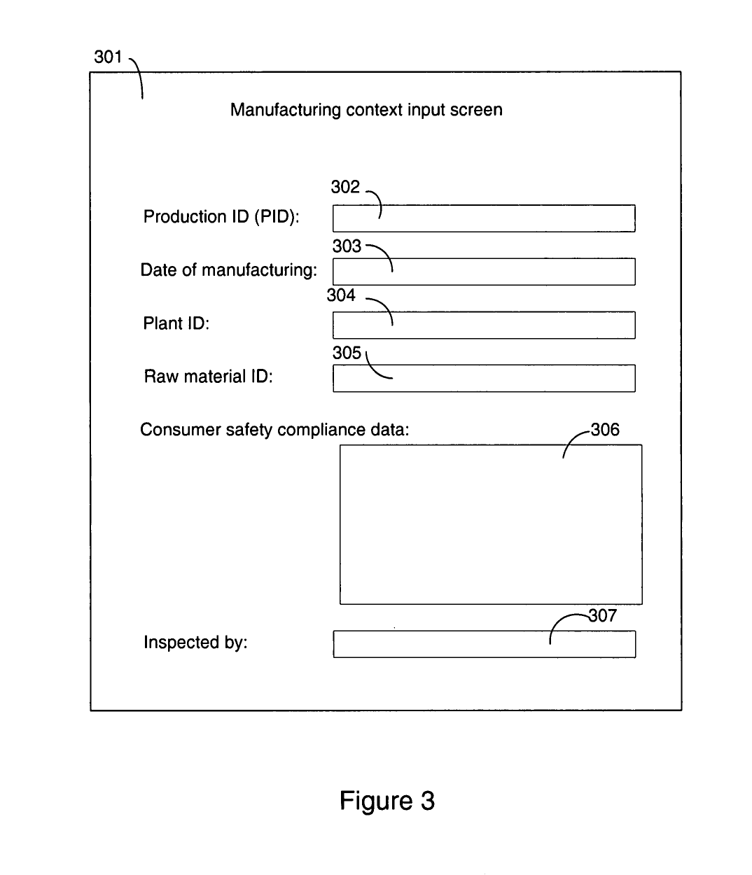

FIG. 3 is a sample of the computer terminal input screen 205 that can be used to input the manufacturing context and PID into the data repository 110,208. The key data is the PID 302. Asides from the PID, information related to the manufacturing that is of interest to the consumer may include the data of manufacturing 303, manufacturing plant ID 304, raw material identifier 305, consumer safety compliance data 306 is likely to include test data collected during product inspection 307.

When the product is destined for a retailer, a retailer ID (RID) that corresponds to the particulars of the retailer is assigned to each product.

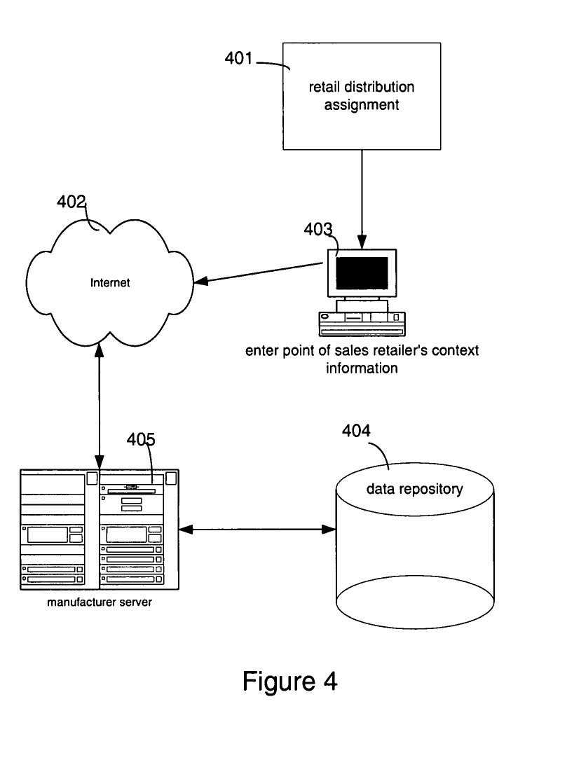

FIG. 4 shows the RID assignment diagram.

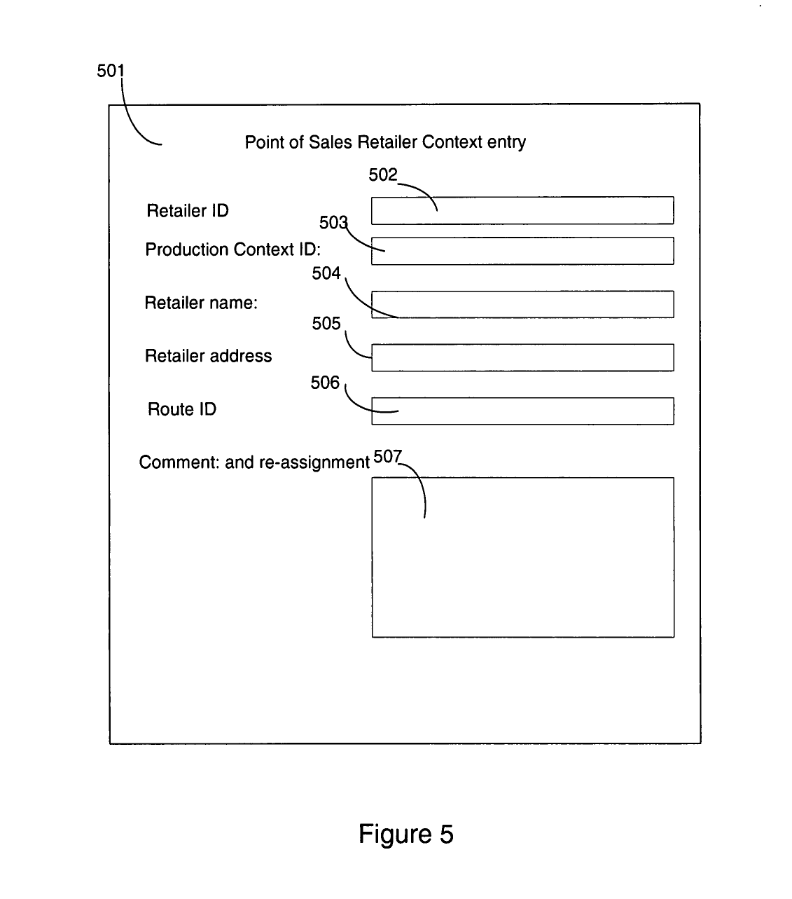

FIG. 5 shows an input screen for the RID assignment. The RID and retailer's context 401, 501 are entered into the manufacturing context data repository 404 through a computer terminal 403 that is connected to the manufacturer's computer server 405 over a computer network 402. The PID 201, 302, 503 of the product is used to locate the particular record for update. The RID will eventually be provided to a consumer when the product is sold. This RID is associated to a product by means of a variety of methods. One method is to label or tag onto the product. Another way is to have the retailer to include the RID in the sales receipt, or alternatively, it can be stamped onto any user documentation or a product registration card. Typical data fields associated with the RID are retailer ID 502, retailer name, retailer address, route ID, comment and re-assignment information 507. The re-assignment information is applicable to retailers with chain stores who prefer to use a common RID to represent all the chain stores. In this case, the store's particulars can be entered so that the consumer can understand the relationship between the common RID and the particular store selling the product.

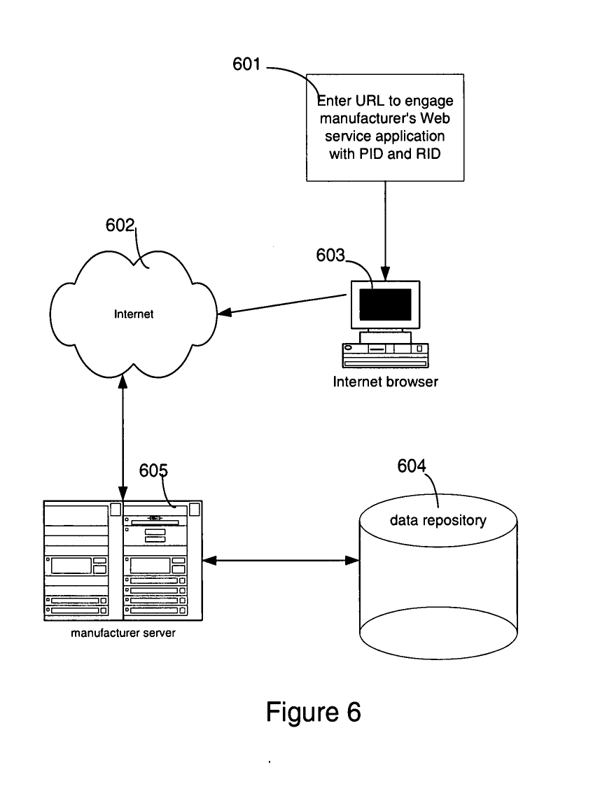

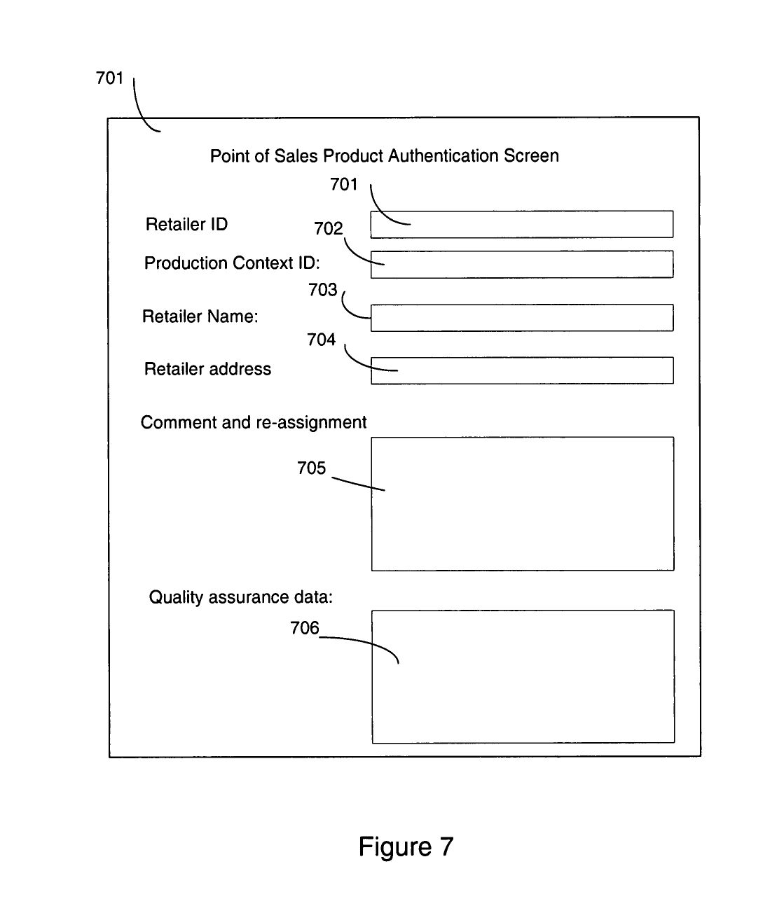

FIG. 6 is a diagram showing the use of an Internet browser to access the manufacturer's server as part of the authentication procedure. When a consumer wants to authenticate a product being sold by a retailer, the URL 601 provided by the manufacturer is entered into an Internet browser. Subsequently, the Web service application 605 will prompt the consumer to enter the PID and RID 601 of the particular product. After the PID and RID are submitted to the Web application 605, a response will be returned indicating if the PID and RID pair is valid or if it is not, then the product is not authenticated. If the PID and RID pair is valid, the relevant manufacturing context and retailer context will be displayed as shown in FIG. 7. The consumer can then examine the retailer name 703, address 704, comment and re-assignment Implementation Details data 705, and quality assurance data 706 to determine if the product is consistent with the identity of the reseller that is selling the product.

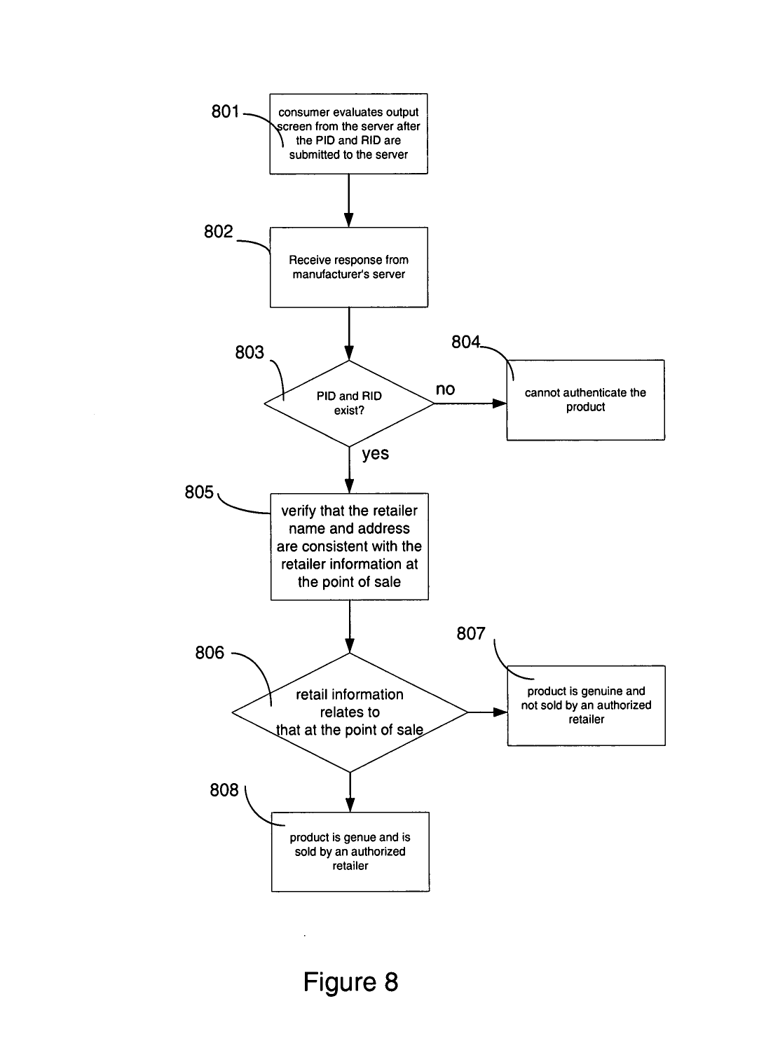

FIG. 8 is a flow chart showing the procedure and decision diagram for the consumer to determine if the product is authentic. A consumer uses an Internet browser to submit to the URL 801 via the Internet to begin a session with the manufacturer's Web site (manufacturer's server). The manufacturer's server responds 803 to the query indicating if record corresponds to the given PID and RID pair is found. If not found 804, the product is not authenticated. If found 805, the consumer is asked to verify the retailer's name and address to be consistent with the context of the retailer selling the product 806. If the retailer's context information represented by the RID is consistent with the identity of the retailer selling the product 808, then the product is authenticated. If not 807, it indicates that the product is genuine but not being sold by a manufacturer authorized reseller.

What is claimed is:

1. A process that enables consumers to obtain the authenticity of a product at the point of sale comprising the following steps:
a. Obtaining the source and quality information of material together with the manufacturing and quality control information to create a production context;
b. Deriving a production identifier to identify said production context;
c. Entry and transmission of said production context into a product database that is hosted in a computer server system owned or operated by a legitimate manufacturer of said manufactured product connected to a computer network;
d. Obtaining the retail and distribution information of a product to create a retail context;
e. Deriving a retail identifier to identify said retail context;
f. Entry and transmission of said retailer context into said product database that is hosted by a computer system connected to a computer network;
g. Storing said production identifier and said retail identifier into said product database by means of a computer system that is connected to a computer network;
h. Publishing said production identifier and said retail identifier with the product;
i. Obtaining said production identifier and said retail identifier from the retail product;
j. Inquiring the authentication of a product by entry and transmission of said production identifier and said retail identifier over a computer network by means of a computer system to the said computer server system hosting the said product database; verifying in the said computer server system using said production context and said retail context and generating a response about the existence of said production context and said retail context, and information derived from the said inquiry to form an authentication context;
k. Determining the authenticity of a product from the said response provided by the said computer server system;

2. The process of claim 1, wherein the production context is expressed in terms of text description, or diagram, picture, image, certificate, table, or codes.

3. The process of claim 1, wherein the retailer context is expressed in terms of text description, or diagram, picture, image, certificate, table, or codes.

4. The process of claim 1, wherein the said inquiry to include information that is associated with the product after it is marked for commerce.

5. The process of claim 1, wherein the production identifier is made up of code and description that is transformed from the production context text.

6. The process of claim 1, wherein the retail identifier is made up of code and description that is transformed from a combination of production context and retail context.

7. The process of claim 1, wherein the production context is collected offline in whole or in part, and then subsequently entered into the computer server system.

8. The process of claim 1, wherein the retail context is collected offline in whole or in part, and then subsequently entered into the computer server system.

9. The process of claim 1, wherein the computer network is a public computer network such as the Internet.

10. The process of claim 1, wherein the computer network is a private computer network such as an intranet within an enterprise.

11. The process of claim 1, wherein the product is a raw material that requires no additional processing.
